(19) United States
(12) Patent Application Publication
(10) Pub. No.: US 2004/0265193 A1
(43) Pub. Date: Dec. 30, 2004

(54) In-line, automated, duct-washing apparatus

(76) Inventors: Ron Panice, Clearwater Beach, FL (US); Thomas Clark, Cohage Grove, WI (US)

Correspondence Address: DEWITT ROSS & STEVENS S.C., Intellectual Property Department, US Bank Building, Suite 401, 8000 Excelsior Drive, Madison, WI, 53717-1914, US

(21) Appl. No.: 10/859,890

(22) Filed: Jun. 3, 2004

Related U.S. Application Data
(60) Provisional application No. 60/475,368, filed on Jun. 3, 2003.

(51) Int. Cl. B01J 19/08; B01J 19/12

(52) U.S. Cl. 422/186.04; 422/186.3

(57) ABSTRACT

Disclosed is an in-line apparatus for sanitizing an internal lumen of a duct system. The apparatus includes a housing with an air inlet manifold and an air discharge manifold defined in the housing; an auto wash sub-assembly disposed within the housing; and an ultraviolet or ionizing radiation source disposed within the housing. The apparatus may also include a one cooling coil, a burner, a steam unit disposed, and/or an electrostatic sub-assembly disposed within the housing. In a preferred arrangement, a pogrammable logic controller is operationally linked to the auto wash sub-assembly, the ultraviolet or ionizing radiation source, the cooling coil, the burner, and the steam unit, and can control these elements according to user-defined, pre-set modes. The device functions to sanitize air that is circulated throughout rooms and buildings via duct systems.

### CROSS-REFERENCE TO RELATED APPLICATIONS

Priority is hereby claimed to provisional application Ser. No. 60/475,368, filed Jun. 3, 2003, the contents of which are incorporated herein by reference.

### FIELD OF THE INVENTION

The invention is directed to an in-line, automated apparatus that cleans and sanitizes duct work. The apparatus prevents potentially harmful microbes from accumulating within duct work, thereby preventing microbes from being introduced into sensitive areas, such as food-handling, processing, and packaging areas, operating rooms, and the like.

### BACKGROUND

Airborne bacteria, fungi, or other microorganisms (collectively referred to as “microbes”) permeate the air we breath. Some of these microbes are harmless; many, however, are pathogens that cause life-threatening diseases. To the extent possible, removing harmful microbes from environments in which humans live and work has been a long-felt and unmet need of the Heating, Ventilating, and Air-Conditioning (HVAC) industry.

For example, medical environments, such as hospitals, present a very dangerous combination of harmful pathogens and susceptible, weakened patients. Thus, the HVAC systems in hospitals surely contribute to the prevalence of nosocomial infections. The development of biological weapons likewise requires that command centers, barracks, ships, fighting vehicles, and other closed environments be protected against biological agents, while still affording their occupants an adequate supply of fresh air. Similarly, modern methods of construction, based upon environmental and energy-conservation principals, yields tightly sealed, high-rise structures serviced by massive, central HVAC systems. The duct work of these systems often provides an ideal and undisturbed environment for the growth and spread of potentially dangerous microbes. The same situation applies in regulated environments, such as food packaging plants, operating theaters, medical equipment manufacturing sites, and the like.

Much effort in the past has gone into trying to destroy atmospheric pathogens, with only limited success being achieved. It has long been recognized that pathogens can be destroyed in the air if they are irradiated with ultraviolet (UV) light at a wavelength of approximately 253.7 nanometers. (This wavelength is often referred to as “germicidal wavelength”.) However, in order for the UV light to kill microbes, the UV rays must directly strike the microorganisms for a sufficient amount of time to cause lethal damage to the cells. Because of the absolute necessity for antiseptic surroundings, UV lamps of the required germicidal wavelength are often used in operating rooms, wards, and nurseries of hospitals.

The exposure to UV light necessary to kill microbes is a product of the time of exposure and the intensity of the applied UV radiation. Generally, however, the maximally effective UV dose is not delivered by conventional devised due to the dangers to humans of long-term UV irradiation. Exposure to UV sources is regulated by the federal government. For example, the occupant exposure limit germicidal wavelength UV ceiling fixtures is 6,000 microwatts seconds/cm² per eight-hour day (ACGIH, NIOSH standard). Thus, the maximum allowed UV intensity exposure per second, under the current federal regulations, is 0.2 microwatts/cm².

At this intensity, eight hours at the allowed exposure level is required to achieve only a 90% lethal dose for hearty microbes such as tuberculosis (Mycobacterium tuberculosis) at head height (the 90% kill-value for tuberculosis is 6200 μW/cm²). The required energy value to achieve 100% lethality in tubercuolosis is 10,000 μW/cm². Using the federal UV intensity standards, this would require more than 13 hours of exposure. As a result, the combination of a federally-mandated maximum UV intensity and the resulting long exposure time required to kill certain harmful microbes, permits microbes to migrate out of range of the UV lamps. Thus, these microbes have an opportunity to accumulate and cause new infections. Increasing the air circulation within any given space does not address this problem because increased circulation simply decreases the amount of time any given microbe spends at the maximum UV intensity.

To overcome these problems, there have been various attempts describe in the prior patents to concentrate circulating air in front of a germicidal UV source. Usually, such systems are free-standing, or wall- or ceiling-mounted devices. These devices circulate the air in a single room, passing the air through the UV enclosure. See, for example, U.S. Pat. No. 5,330,722, to Pick, which discloses a germicidal air purifier which draws air through a chamber in which there is mounted UV source which fucntions to kill microbes trapped within the filter structure. Similarly, U.S. Pat. No. 5,612,001, to Matschke, describes a germicidal air cleansing enclosure having an internal ellipsoid chamber which contains UV lamps along the major axis of the ellipsoid. The unit is free-standing and treats air in a single room.

A major drawback of these types of systems, however, is that conventional HVAC systems still allow circulation of untreated air into and out of any given room. The internal lumen of the HVAC system also provides an ideal environment in which microbes can thrive. In short, the inner volume of an HVAC system is enclosed, is certainly temperature-controlled, and is very often humidity-controlled as well. Microbes that establish themselves within the duct work are then spread from room to room as air is mechanically forced through the duct work by central fans. This allows untreated air containing pathogens to spread from one location to another. This contaminated air can then come into contact with humans, food, pharmaceuticals, etc., before being treated by (for example) a free-standing UV germicidal unit.

Various attempts have been made to place UV sources within an HVAC duct system, thereby to germicidally clean the air as is passes through the ducts. See, for example, U.S. Pat. No. 5,635,133, to Glazman; U.S. Pat. No. 5,200,156, to Wedekamp; and U.S. Pat. No. 5,107,687, to Candelero. Each of these patents describes a UV source in a duct to cleanse a fluid (air or liquid) traveling through a duct of uniform diameter. The UV source is disposed perpendicularly to the duct walls and UV energy is directed, at least in part, along the path of fluid flow. Thus, the level of ultraviolet energy varies along the flow path. As a result, the air circulated past the UV lamps in the prior art devices receives an uneven distribution of ultraviolet energy and a rapid diminution of energy levels outside the immediate area of the UV source. Microbes that make their way past the UV source without receiving a lethal dose of radiation are then able to contaminate downstream areas serviced by the HVAC system.

The present invention is designed to address the shortcomings of the prior art devices.

### SUMMARY OF THE INVENTION

Thus, a first embodiment of the invention is directed to in-line apparatus for sanitizing the internal lumen of a duct system. According to the first embodiment, the apparatus comprises a housing disposed in-line with the duct system to be sanitized. By the term “in line” is meant that the inventive apparatus (once installed) forms an integral party of the duct system itself. The housing has at least one air inlet manifold and at least one air discharge manifold (for admitting air into the housing and venting air from the housing, respectively). Both the air inlet manifold and the air outlet manifold can be switched between an open position and an air-tight closed position. An auto wash sub-assembly is disposed within the housing. The auto wash sub-assembly functions to wash the lumen of the duct system. Also disposed within the housing is an ultra-violet (UV) or ionizing radiation source. The UV or ionizing radiation source is situated within the housing such that air entering the housing via the air inlet manifold is exposed to the UV or ionizing radiation source for a time sufficient to kill microbes present in the air within the housing.

It is preferred that the ultraviolet radiation source emits radiation comprising a wavelength of from about 185 nm to about 300 nm. If an ionizing radiation source is used, a corona discharge-type device is preferred. The apparatus may also include an electrostatic sub-assembly disposed within the housing. The electrostatic sub-assembly is dimensioned and configured to kill microbes using lethal electrical or electronic interactions.

It is preferred that at least one filter be disposed within each of the air inlet manifold and the air discharge manifold. The filters are preferably dimensioned and configured to have a nominal cutoff value sufficiently small to inhibit or prevent passage of microbes through the filters.

It is also preferred that the apparatus further comprise a positive-closing duct system (PCDS). The PCDS comprises, in combination, a corresponding door and a actuator for every vent present in the duct system to be sanitized, wherein the actuator is dimensioned and configured to move its corresponding door between a closed position and an open position. A programmable logic controller is preferably operationally linked to the PCDS, wherein the programmable logic controller is user-programmable to move the doors of the PCDS between the closed and open positions, as well as the intake and discharge manifolds present in the housing.

As used herein, the term “operationally linked” or “operationally connected” means that the programmable logic controller is capable of sending and receiving signals from the various devices and sub-assemblies which it is tasked with controlling. This can be done via hard-wired connections or via wireless transmitters/receivers.

A second embodiment of the invention is directed to an in-line apparatus for sanitizing an internal lumen of a duct system. Here, the apparatus comprises a housing as described earlier, along with an auto wash sub-assembly and an ultraviolet or ionizing radiation source disposed within the housing. The second embodiment also comprises the positive-closing duct system (PCDS) and a programmable logic controller operationally linked to the auto wash sub-assembly, the ultraviolet or ionizing radiation source, and the PCDS, wherein the programable logic controller is user-programmable to operate the auto wash sub-assembly and the ultraviolet or ionizing radiation source in pre-set modes and to move the doors of the PCDS between the closed and open positions.

A third embodiment of the invention is directed to an in-line apparatus for sanitizing an internal lumen of a duct system. In the third embodiment, the apparatus comprises: a housing as described above, and at least one air inlet manifold and at least one air discharge manifold defined in the housing, wherein both the air inlet manifold and the air outlet manifold can be switched between an open position and an air-tight closed position. The apparatus further comprises: an auto wash sub-assembly disposed within the housing; an ultraviolet or ionizing radiation source disposed within the housing such that air entering the housing via the air inlet manifold is exposed to the UV or ionizing radiation source for a time sufficient to kill microbes present in the air within the housing; at least one cooling coil, at least one burner, and at least one steam unit disposed within the housing; and an electrostatic sub-assembly disposed within the housing, wherein the electrostatic sub-assembly is dimensioned and configured to kill microbes using lethal electrical or electronic interactions. The third embodiment of the invention also includes a positive-closing duct system (PCDS) comprising, in combination, a corresponding door and a actuator for every vent present in the duct system to be sanitized, wherein the actuator is dimensioned and configured to move its corresponding door between a closed position and an open position; and a programmable logic controller operationally linked to the auto wash sub-assembly, the ultraviolet or ionizing radiation source, the cooling coil, the burner, the steam unit, and the PCDS, wherein the programable logic controller is user-programmable to operate the auto wash sub-assembly, the ultraviolet or ionizing radiation source, the cooling coil, the burner, and the steam unit in pre-set modes, and to move the doors of the PCDS between the closed and open positions.

### BRIEF DESCRIPTION OF THE DRAWINGS

FIG. 1 is a top plan schematic view of an in-line, automated duct washing system according to the present invention.

FIG. 2 is a front elevation view of the in-line, automated duct washing system depicted in FIG. 1.

FIGS. 3A, 3B, and 3C are top plan, front elevation, and right-side elevation, respectively, of a positive-closing duct exhaust vent according to the present invention. As shown in FIGS. 3A, 3B, and 3C, the exhaust vent is closed.

FIGS. 4A, 4B, and 4C are top plan, front elevation, and right-side elevation, respectively, of a positive-closing duct exhaust vent as shown in FIGS. 3A, 3B, and 3C, but wherein the exhaust vent is depicted in the open position.

FIG. 5 is a front elevation showing three positive-closing duct exhaust vents, all in the closed position.

### DETAILED DESCRIPTION OF THE INVENTION

The primary aim and goal of the present invention is to provide clean, microbe-free air into a defined space. In a preferred embodiment, the apparatus of the present invention is used in conjunction with conventional HVAC equipment to introduce microbe-free air into areas where the presence of microbes is deleterious, such as food-packaging and processing areas, clean rooms, and the like. The apparatus includes an auto wash sub-assembly and a positive-closing duct system (PCDS) to allow high-temperature and high-pressure washing and sanitizing of the entire internal lumen of a duct system. Using the present apparatus, detergents or other cleaning agents can be introduced into the duct system to accomplish the task of cleaning, and these cleaning agents can also be rinsed from the inside of the duct works.

The apparatus preferably includes positive-sealing, pre-cabinet entrance cylinder-type cartridge filters, such as HEPPA filters and the like. This prevents microbes from being drawn into the duct works during the operation of the present invention.

Air contained within the duct work to be cleaned is exposed to two or more means for killing microbes, such means including, but not limited to: ultraviolet germicidal irradiation systems (i.e., systems that kill microbes via ultraviolet radiation), corona discharge systems (i.e., systems that kill microbes via of ionization), electrostatic systems (i.e., systems that kill microbes using lethal electrical or electronic interactions), high-heat (steam, gas, electric, or otherwise), and high-pressure.

The apparatus is preferably comprises an all-welded, double-walled, stainless steel unit, dimensioned and configured with smooth internal surfaces that lack crevices, cracks or voids of any sort. In short, the internal lumen of the device lacks spaces in which microbes can hide and thrive. By eliminating the harboring areas found in virtually all conventional HVAC equipment, microbes are more likely to be exposed to the killing effects of the present invention.

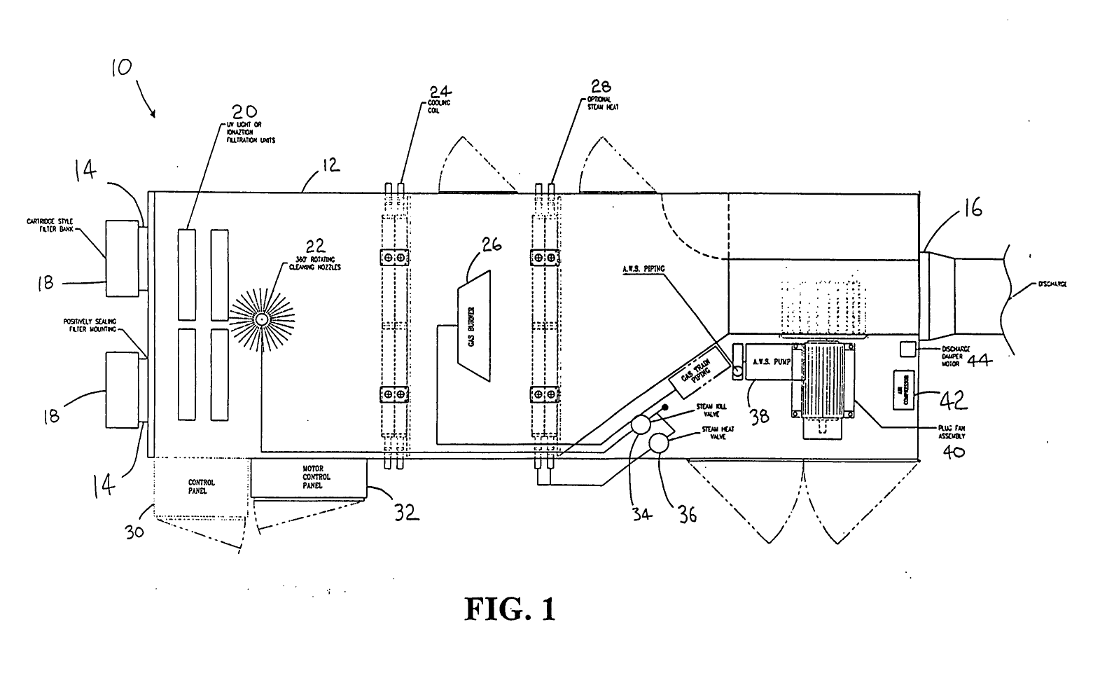

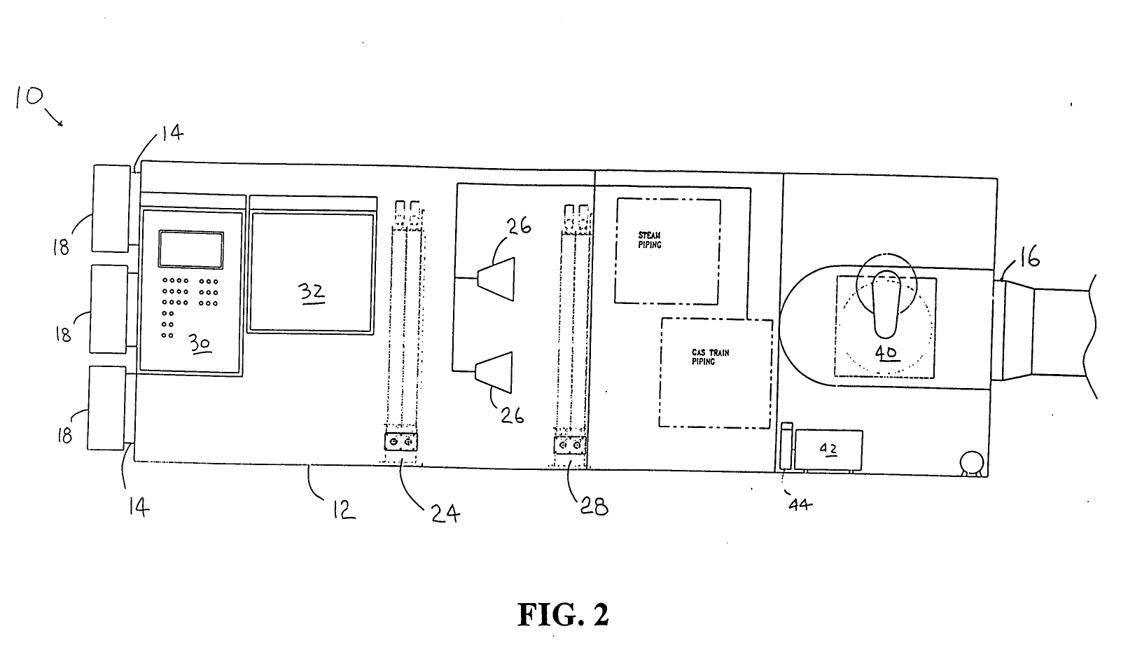

Referring now to the drawing figures, where the same references numerals are used throughout all of the drawings to refer to the same elements, FIG. 1 is a top plan schematic view of an in-line, automated duct washing system according to the present invention. FIG. 2 is a front elevation view of the in-line, automated duct washing system depicted in FIG. 1. Specifically referring to these two figures, the figures show an in-line duct washing apparatus 10, that includes a housing 12, inlet manifold(s) 14, discharge manifold(s) 16, filters 18, UV or ionizing radiation source(s) 20, cleaning nozzle(s) 22, cooling coil(s) 24, burner 26, steam unit 28, control panels 30 and 32, control valves 34 and 36, wash pump 38, fan 40, air compressor 42, and discharge damper motor 44

Air moves through the apparatus from left to right as shown in FIGS. 1 and 2. Air is drawn from outside housing 12 to the within the housing via the action of fan 40. The air first passes through filters 18, then through inlet manifolds 14 to gain entrance into the inside of the housing 12. The filters 14 are preferably cartridge-style, positive seating filters, much like those used in particle respirators and the like. The filters can be fabricated from any filter material now know to the art or developed in the future. Paper, plastic, activated charcoal, and other types of filters are all suitable for use in the present invention.

Once air enters the housing, it is immediately exposed to a UV or ionizing radiation source 20. For sake of brevity, this element shall be referred to as simply the UV source 20. The UV source 20 can be any type of UV source, preferably one that generates light in wavelengths ranging from about 200 nm to about 300 nm. Ultraviolet radiation in the 200-300 nanometer (nm) range is extremely effective in killing microbes such as airborne and surface bacteria, viruses, yeasts and molds. Generally low-pressure, mercury-arc germicidal lamps are preferred. These lamps are dimensioned and configured to produce the highest amounts of UV radiation. The preferred bulbs typically generate about 90% of their total rated energy at 253.7 nm, the optimal germicidal wavelength. This wavelength of radiation is readily attainable using a mercury-based source, and is very close to the peak of the germicidal effectiveness curve (generally about 265 nm), the most lethal wavelength to microorganisms. Such lamps are available from a host of national and international suppliers, such as Light Sources, Inc., Orange, Conn. Light sources that simultaneously generate energy at 185 nm may also be used. This UV emission produces abundant amounts of ozone in air. Ozone is an extremely active oxidizer, and destroys microorganisms on contact. Ozone also acts as a deodorizer. One advantage of ozone is that it can be carried by air into places that the UV radiation might not reach directly.

The duct work itself is mechanically cleaned via cleaning nozzle 22. The nozzle is of conventional design. It provides a detergent/water wash, followed by a water rinse, to the inside of the housing 12. The nozzle is powered by pump 38

Cooling coils 24 are provided to maintain the internal temperature of the housing 12 within pre-set, operator-defined limits. The cooling coils are of conventional design and configuration.

Gas burner(s) 26 heat the interior of the housing, as does option steam heat unit 28. In combination, these two units elevate the temperature within the housing 12 to the point that many microbes are killed. Valves 34 and 36 control operation of the steam heat unit. Suitable steam heat units include those manufactured by Spirax Sarco Steam Valve. After air has passed beyond the steam unit 28, fan 40 moves the air into the main HVAC duct work.

The entire operation of the device is controlled electronically via control panels 30 and 32. The electrical wiring has been omitted from the figures for purposes of clarity.

A distinct advantage of the present system is that all of the mechanical aspects of the invention, such as the motors and motor windings, bearings, electrical wire harnesses, drive belts, valves, actuators and controls are located outside of the housing 12. Thus, when operating, none of the control elements of the invention are exposed to the harsh environment present within the housing.

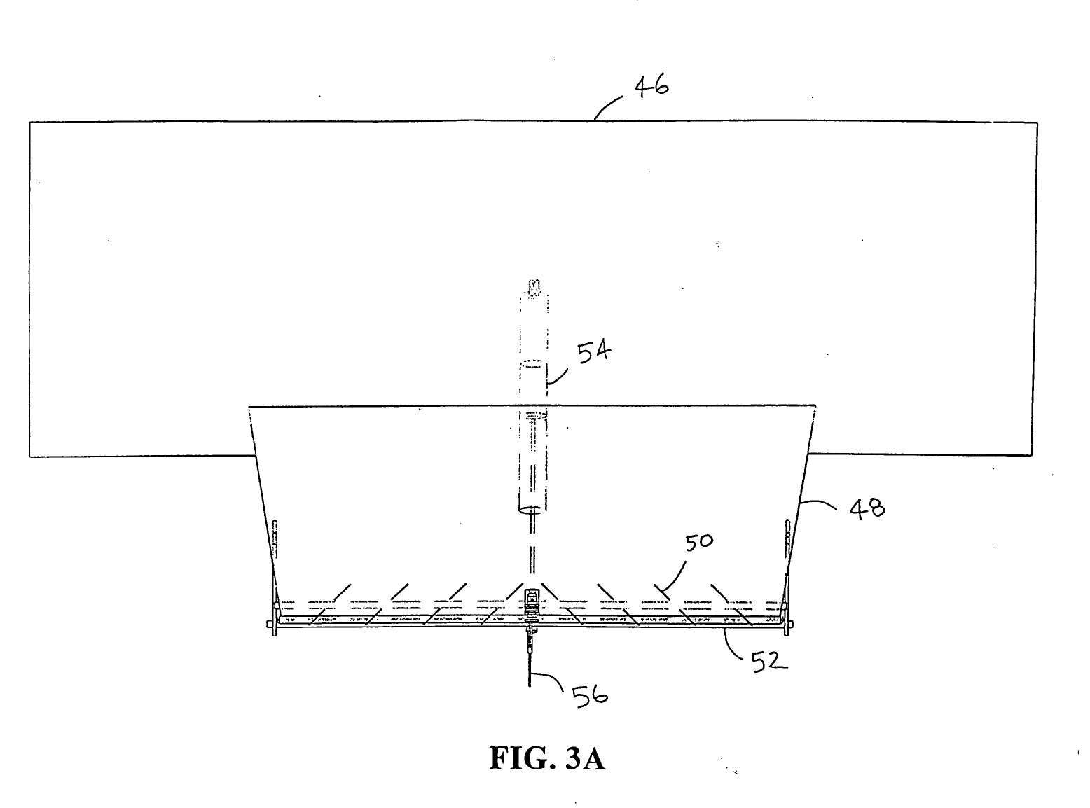

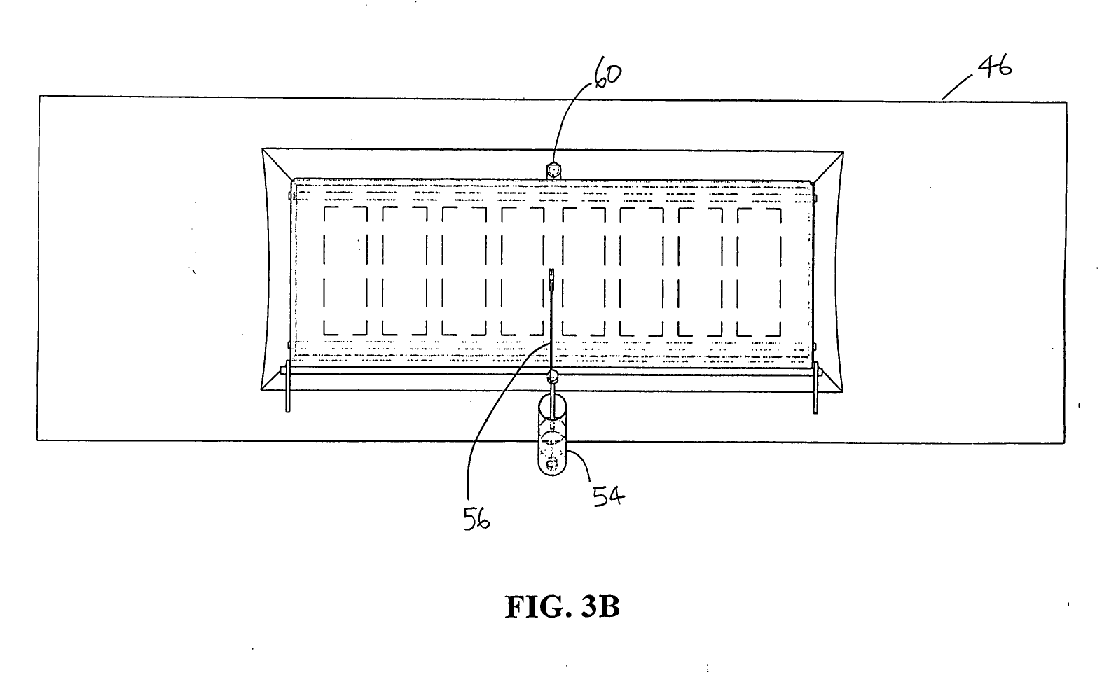

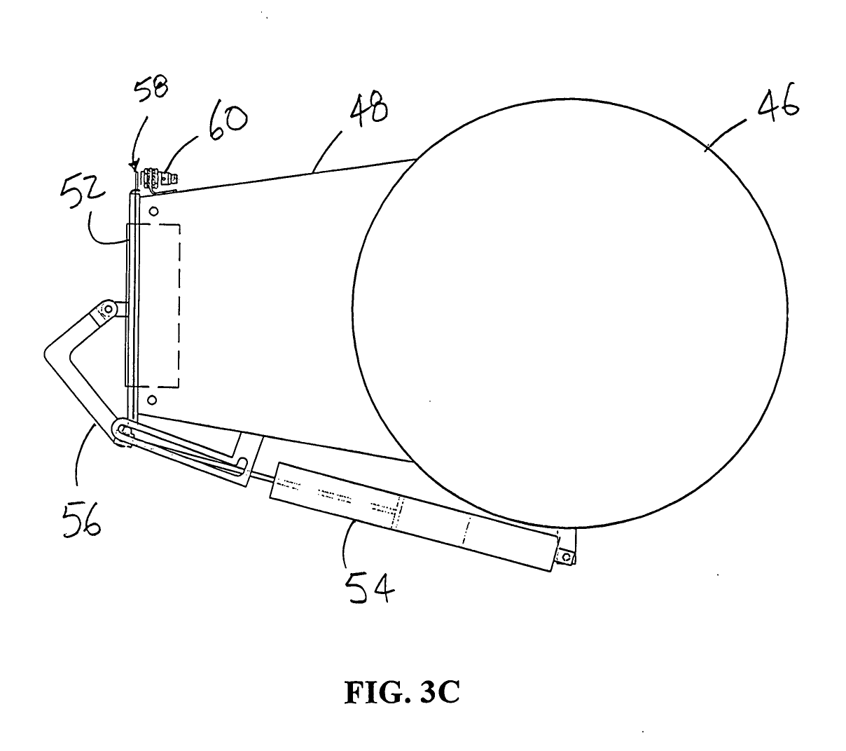

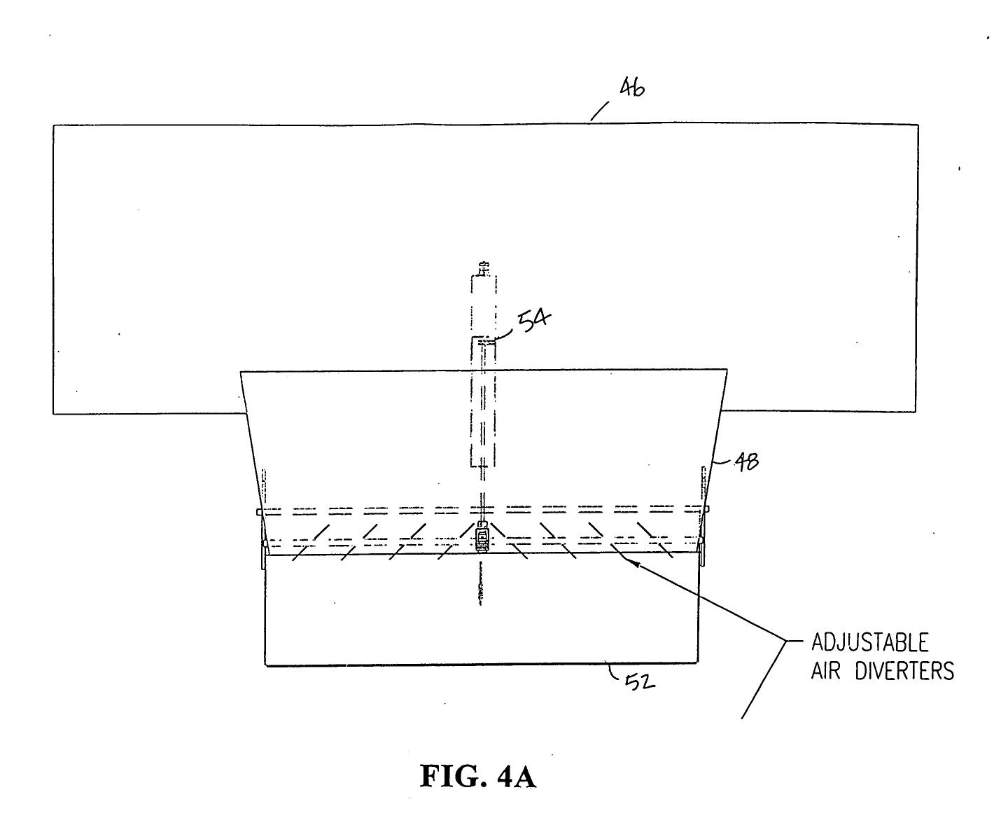

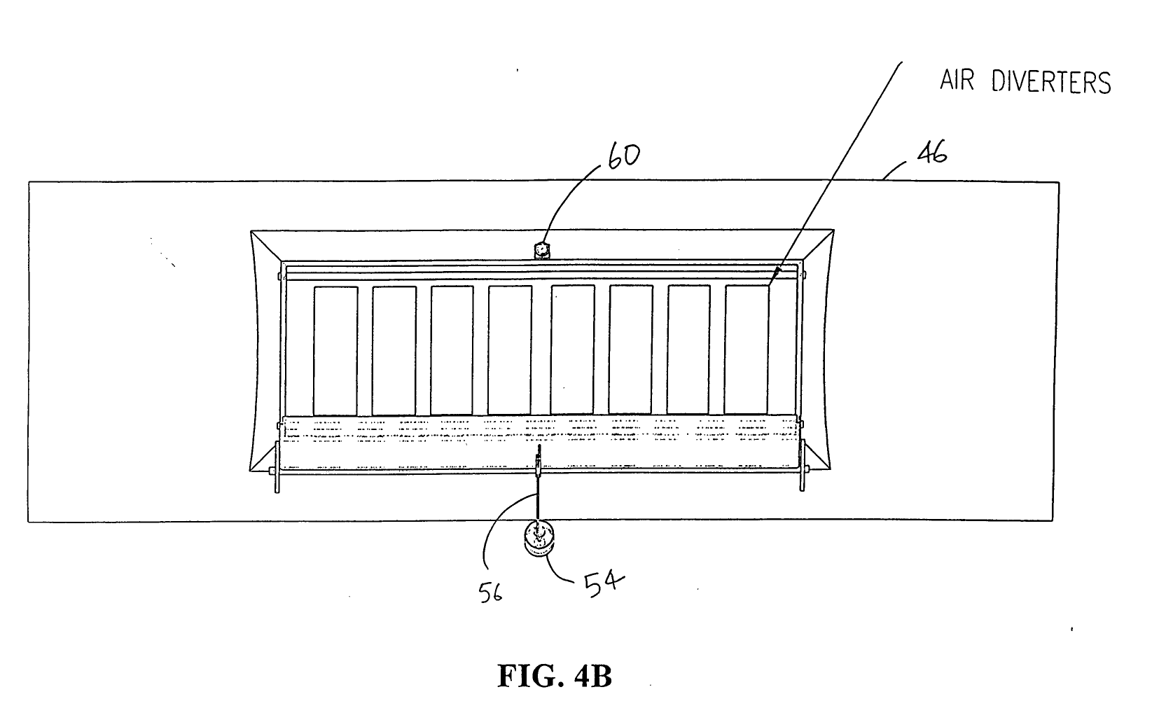

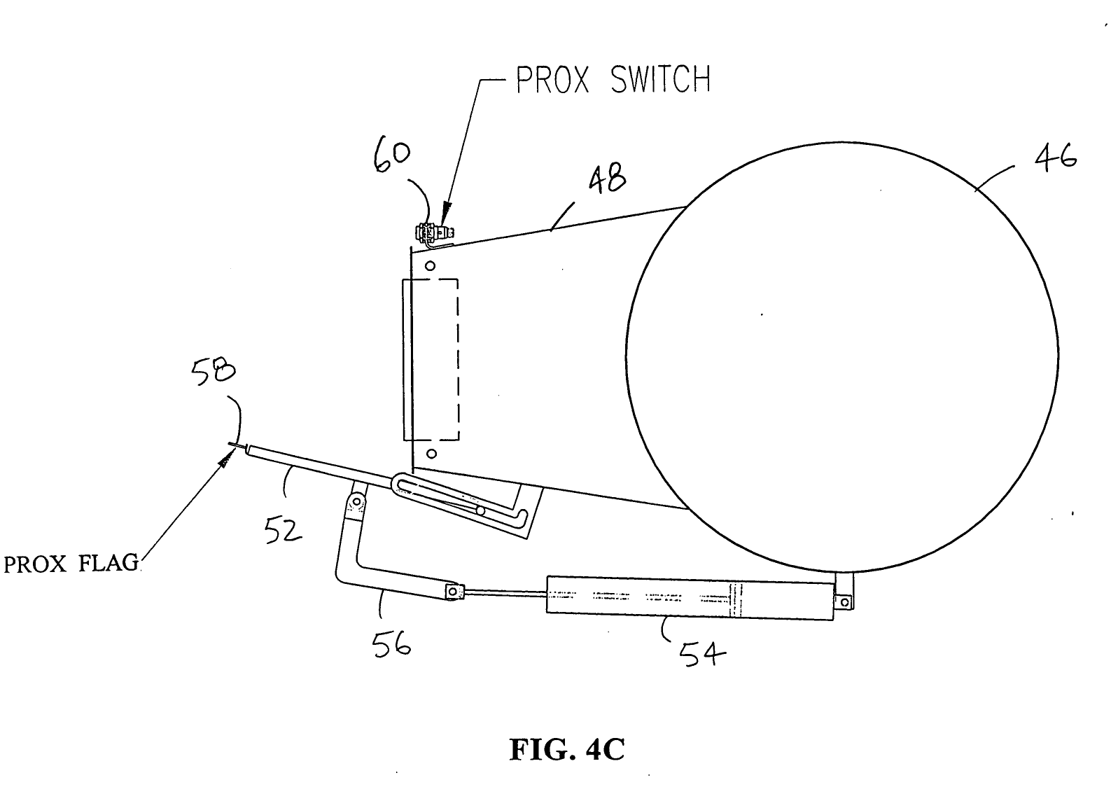

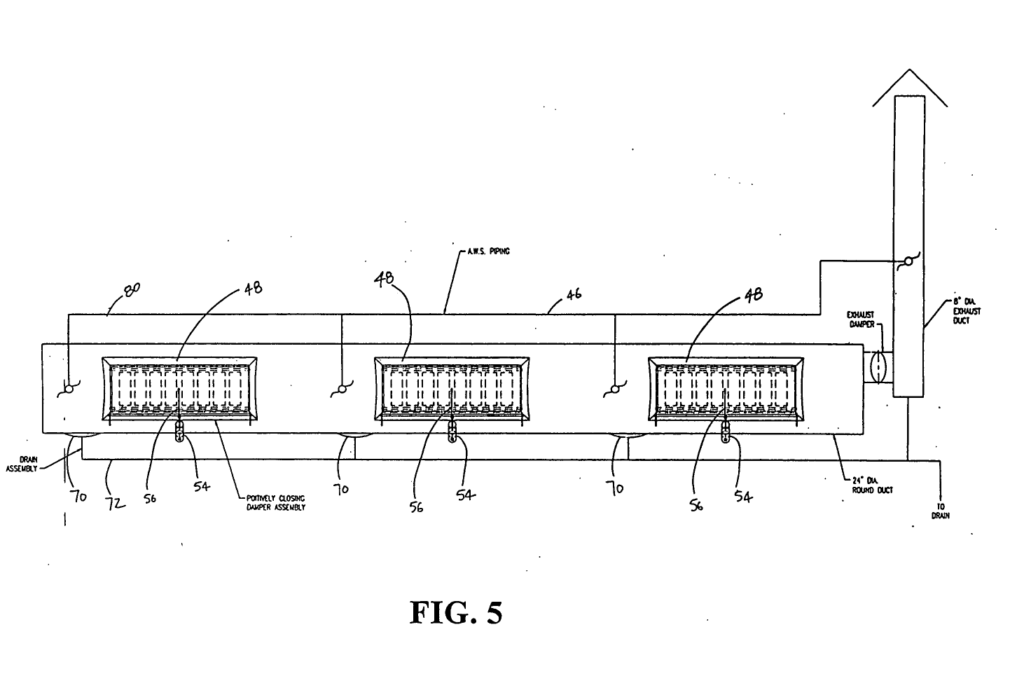

A key aspect of the invention is illustrated in FIGS. 3A, 3B, 3C, 4A, 4B, 4C, and 5. Specifically, any HVAC system includes a host of vents 48 where air exits the HVAC system into the space serviced by the system. Such vents conventionally include louvers 50, although louvers are not required in the present invention. In the present invention, these vents can be physically and automatically sealed prior to the wash cycle being initiated. Thus, as shown in FIGS. 3A, 3B, 3C, 4A, 4B, 4C, and 5 the main HVAC duct 46 adjoins one or more vents 48. In the present invention, each vent 48 has associated with it a door 52, affixed to a connector 56, which is in turn affixed to an actuator 54. The actuator 54 and connector 56 function in combination to move the door 52 between a closed position (shown in FIGS. 3A, 3B, 3C, and 5) and an open position (shown in FIGS. 4A, 4B, and 4C).

As shown in the figures, the actuator 54 is shown as a piston-type actuator and the door 52 is shown as being hinged. Of course, a vast array of equivalent arrangements are encompassed by the present invention. Thus, the actuator can be of any configuration, without limitation, including pneumatic and hydraulic actuators, electric and/or electronic actuators, magnetic actuators, etc. In short, any actuator that will function to move the door 52 between an open and a closed position is suitable for use in the present invention. Likewise, the door 52 may be attached to the vent 48 via hinges as shown in the figures, of via a sliding arrangement, an accordion type arrangement, etc. The door 52 as shown in the figures is a single, monolithic element. However, multi-part doors, ocular closures, sphincter-type closures and the like, are within the scope of the present invention. In short, the door may comprise any physical arrangement of parts that serves to seal the vent 48. The open or closed status of the door can be monitored via sensor 60, which is actuated by tab 58 as shown in the figures.

In operation, then, while the UV source may operate continuously (which is preferred), the wash cycle is operated periodically and generally on a pre-set, predetermined, and operator-programmable schedule. Thus, prior to the wash cycle beginning, all of the vents 48 (or a predetermined sub-set of vents) within the HVAC system serviced by the present invention are sealed. Once the HVAC system is sealed, it can be charged with a detergent solution via nozzle 22 and the interior temperature elevated via burner 26. Steam may be circulated throughout the sealed HVAC duct work via steam heat unit 28.

As shown in FIG. 5, the duct work 46 includes one or more drains 70 and associated drain plumbing 72. Thus, by sealing the vents, the HVAC ducts can be charged with high-temperature cleaning solution and/or steam. After a desired amount of cleaning has taken place, the ducts can be charged with clean water. Both the detergent solutions and the clean rinse water is vented from the ducts through drains 70 and the associated plumbing 72.

In this fashion, the present invention functions to maintain a virtually sterile HVAC environment, suitable for use in food packaging plants, hospitals, and in any environment where pathogen-free air is desired.

In terms of operational control, the invention is logically controlled by conventional Programmable Logic Controller, and preferably interfaced with a Human Machine Interface to provide ease of operation and programmability. The primary focus of the controller is to allow the system to maintain user-defined temperatures achieved by the combination of the burner(s) 26, steam heat units 28 and cooling coils 24. The controller also allows static and/or dynamic pressure control within the duct work using various sensor capabilities, such as frequency drivers and pressure transducer sensing capabilities.

Generally, the period wash cycle is triggered by hours of run time of the HVAC system as a whole. The hours of run time are logged and after a pre-set passage of time an alarm is activated indicating that the HVAC system should be washed. Once the alarm is acknowledged the controller will then alter its primary control focus, shifting the controller priorities into the Auto Wash Mode (AWM). Once in the AWM, the controller will first positively seal and close the doors 52, via action of the actuators 54. The sensors 60 confirm that the doors are safely closed. The fan 40 is then activated to circulate air through the now-closed ducts and the wash cycle is initiated, as described earlier. This now allows heated air, steam, detergent solutions, etc. to travel throughout the HVAC duct work 46. After the wash cycle is complete a final rinse takes place, again followed by a high temp steam injection delivered by the steam heat unit 28. Lastly, a drying operation is initiated to ensure that the lumen of the HVAC duct work is thoroughly and completely dry. The positive-closing duct system will then re-open the vents 48 and the HVAC system resumes normal operation.

What is claimed is:

1. An in-line apparatus for sanitizing an internal lumen of a duct system, the apparatus comprising:
a housing disposed in-line with the duct system to be sanitized;
at least one air inlet manifold and at least one air discharge manifold defined in the housing, wherein both the air inlet manifold and the air outlet manifold can be switched between an open position and an air-tight closed position;
an auto wash sub-assembly disposed within the housing; and
an ultraviolet or ionizing radiation source disposed within the housing such that air entering the housing via the air inlet manifold is exposed to the UV or ionizing radiation source for a time sufficient to kill microbes present in the air within the housing.

2. The apparatus of claim 1, comprising an ultraviolet radiation source that emits radiation comprising a wavelength of from about 200 nm to about 300 nm.

3. The apparatus of claim 1, comprising an ultraviolet radiation source that emits radiation comprising a wavelength of from about 185 nm to about 300 nm.

4. The apparatus of claim 1, comprising an ionizing radiation source that is a corona discharge device.

5. The apparatus of claim 1, further comprising an electrostatic sub-assembly disposed within the housing, wherein the electrostatic sub-assembly is dimensioned and configured to kill microbes using lethal electrical or electronic interactions.

6. The apparatus of claim 1, further comprising at least one filter disposed within each of the air inlet manifold and the air discharge manifold, the filters dimensioned and configured to prevent passage of microbes through the filters.

7. The apparatus of claim 6, wherein the filters are positive-seating, cylinder-type cartridge filters.

8. The apparatus of claim 6, wherein the filters are high-efficiency particulate air filters.

9. The apparatus of claim 1, further comprising a positive-closing duct system (PCDS), wherein the PCDS comprises, in combination, a corresponding door and a actuator for every vent present in the duct system to be sanitized, wherein the actuator is dimensioned and configured to move its corresponding door between a closed position and an open position.

10. The apparatus of claim 9, further comprising a programmable logic controller operationally linked to the PCDS, wherein the programable logic controller is user-programmable to move the doors of the PCDS between the closed and open positions.

11. The apparatus of claim 1, further comprising at least one cooling coil, at least one burner, or at least one steam unit disposed within the housing.

12. An in-line apparatus for sanitizing an internal lumen of a duct system, the apparatus comprising:
a housing disposed in-line with the duct system to be sanitized, the duct system having a plurality of vents defined therein;
at least one air inlet manifold and at least one air discharge manifold defined in the housing, wherein both the air inlet manifold and the air outlet manifold can be switched between an open position and an air-tight closed position;
an auto wash sub-assembly disposed within the housing;
an ultraviolet or ionizing radiation source disposed within the housing such that air entering the housing via the air inlet manifold is exposed to the UV or ionizing radiation source for a time sufficient to kill microbes present in the air within the housing;
a positive-closing duct system (PCDS) comprising, in combination, a corresponding door and a actuator for every vent present in the duct system to be sanitized, wherein the actuator is dimensioned and configured to move its corresponding door between a closed position and an open position;
a programmable logic controller operationally linked to the auto wash sub-assembly, ultraviolet or ionizing radiation source, and the PCDS, wherein the programable logic controller is user-programmable to operate the auto wash sub-assembly and the ultraviolet or ionizing radiation source in pre-set modes and to move the doors of the PCDS between the closed and open positions.

13. The apparatus of claim 12, comprising an ultraviolet radiation source that emits radiation comprising a wavelength of from about 185 nm to about 300 nm.

14. The apparatus of claim 12, comprising an ionizing radiation source that is a corona discharge device.

15. The apparatus of claim 12, further comprising an electrostatic sub-assembly disposed within the housing, wherein the electrostatic sub-assembly is dimensioned and configured to kill microbes using lethal electrical or electronic interactions, and further wherein the electrostatic sub-assembly is operationally linked to the programmable logic controller.

16. The apparatus of claim 12, further comprising at least one filter disposed within each of the air inlet manifold and the air discharge manifold, the filters dimensioned and configured to prevent passage of microbes through the filters.

17. The apparatus of claim 16, wherein the filters are positive-seating, cylinder-type cartridge filters.

18. The apparatus of claim 16, wherein the filters are high-efficiency particulate air filters.

19. The apparatus of claim 12, further comprising at least one cooling coil, at least one burner, or at least one steam unit disposed within the housing, wherein the at least one cooling coil, the at least one burner, or the at least one steam unit is operationally linked to the programmable logic controller.

20. An in-line apparatus for sanitizing an internal lumen of a duct system, the apparatus comprising:
a housing disposed in-line with the duct system to be sanitized, the duct system having a plurality of vents defined therein;
at least one air inlet manifold and at least one air discharge manifold defined in the housing, wherein both the air inlet manifold and the air outlet manifold can be switched between an open position and an air-tight closed position;
an auto wash sub-assembly disposed within the housing;
an ultraviolet or ionizing radiation source disposed within the housing such that air entering the housing via the air inlet manifold is exposed to the UV or ionizing radiation source for a time sufficient to kill microbes present in the air within the housing;
at least one cooling coil, at least one burner, and at least one steam unit disposed within the housing;
an electrostatic sub-assembly disposed within the housing, wherein the electrostatic sub-assembly is dimensioned and configured to kill microbes using lethal electrical or electronic interactions;
a positive-closing duct system (PCDS) comprising, in combination, a corresponding door and a actuator for every vent present in the duct system to be sanitized, wherein the actuator is dimensioned and configured to move its corresponding door between a closed position and an open position; and
a programmable logic controller operationally linked to the auto wash sub-assembly, the ultraviolet or ionizing radiation source, the cooling coil, the burner, the steam unit, and the PCDS, wherein the programable logic controller is user-programmable to operate the auto wash sub-assembly, the ultraviolet or ionizing radiation source, the cooling coil, the burner, and the steam unit in pre-set modes, and to move the doors of the PCDS between the closed and open positions.
